(19) United States
(12) Patent Application Publication
(10) Pub. No.: US 2010/0309304 A1
(43) Pub. Date: Dec. 9, 2010

(54) Method and Device for the Reconstruction of the Shape of an Object from a Sequence of Sectional Images of Said Object

(76) Inventors: Bernard Chalmond, Louveciennes (FR); Alain Trouve, Paris (FR); Yong Yu, Gentilly (FR); Jiaping Wang, Antony (FR); Olivier Renaud, Paris (FR); Spencer Shorte, Saint Piat (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/739,006

(22) PCT Filed: Oct. 22, 2008
(86) PCT No.: PCT/FR2008/001483

§ 371 Date: Jun. 23, 2010

(30) Foreign Application Priority Data
Oct. 24, 2007 (FR) 0707480

(51) Int. Cl. H04N 7/18; G06K 9/00

(52) U.S. Cl. 348/79; 382/154; 348/E07.085

(57) ABSTRACT

A method of reconstructing the volume of an object from a sequence of section images, the images corresponding to different positions and/or orientations of an acquisition plane and being subject to uncertainties, the method comprising:
a) selecting a finite base of functions on which the volume for reconstruction can be decomposed;
b) selecting a first quantification function for quantizing the difference between the real position and/or orientation of each section relative to said object and its nominal position and/or orientation;
c) selecting a second quantification function for quantizing the spatial coherence of the reconstructed volume;
d) selecting a third quantification function for quantizing the difference between the section images of the object and the corresponding sections of the reconstructed volume;
e) selecting an overall cost function, of value that depends on the values of said first, second, and third quantizing functions; and
f) jointly estimating the real positions and/or orientations of the section, together with the coefficient for decomposing the image of the object on said function base, by minimizing said overall cost function.

The invention relates to a method of reconstructing the volume of an object from a sequence of section images of said object, the positions of said sections relative to the object being known in uncertain manner.

The invention applies in particular, but in non-limiting manner, to confocal microscopy.

Reconstructing a three-dimensional image of the volume of an object from a sequence of two-dimensional section images of said object is a powerful research tool, particularly in biology and medicine.

Numerous mathematical methods have been developed for solving the problem of reconstruction. Those methods are generally based on the assumption that the positions and the orientations of the section planes relative to the object for reconstruction are known accurately. Unfortunately, that assumption is not always satisfied, particularly when the object for reconstruction presents microscopic dimensions.

The object by S. Brant and M. Mevorah “Camera motion recovery without correspondence from microrotation sets in wide-field light microscopy” (Proceedings of the Statistical Methods in Multi-image and Video Processing Workshop—ECCV 2006, Graz, Austria, May 2006) outlines a reconstruction technique that takes account of the instability of the positions of the section planes. In accordance with that method, the movements in rotation of the section planes are estimated from an auto-correlation function of the sequence of images, expressed in the form of a one-dimensional time sequence, and the movements in translation are estimated by segmenting the images and repositioning their centers of mass. Thereafter, the estimates are refined by Bayesian inversion. The effectiveness of that method relies on assumptions that are not always realistic, in particular when the section images are obtained by scanning confocal microscopy or by other techniques of imaging by fluorescence.

Scanning confocal microscopy is a microscopy technique that is well known and that enables an image to be obtained of a section of an object such as a cell, said section corresponding to the focal plane of the microscope. By successively shifting the focal plane, a series of two-dimensional images are acquired from which the volume of the object can be reconstructed in three dimensions.

That technique can be applied only to articles that are capable of being fixed to a substrate, such as adherent cells. Unfortunately, numerous cells, and in particular those of the immune system, are not adherent, and therefore cannot be reconstructed in that way.

Document EP 1 413 911 describes a microscope fitted with a container having a set of electrodes that enable an object in suspension to be manipulated in said container. By subjecting said object in suspension to movements in translation and/or rotation while the focal plane of the microscope is held stationary, it becomes possible to acquire a succession of section images of said object.

Acquiring a succession of sections obtained by movements in rotation is particularly advantageous, since it serves to minimize axial aberration, an artifact that results from the fact that the axial resolution of a confocal microscope is not as good as its transverse revolution (about half as good).

The main limitation of that technique lies in the fact that the movement of the object in the container can be controlled in imperfect manner only, for various reasons, including Brownian motion. As a result the positions and/or orientations of the sections in the volume of said object are subject to uncertainty. This situation can be modeled by considering that a random movement in translation and/or rotation is superposed on the nominal movements in translation and/or in rotation of the object.

Under such conditions, the reconstruction techniques known in the prior art cannot be applied.

A first attempt at taking account of movement uncertainties is described in the object “Camera motion recovery without correspondence from microrotation sets in wide-field light microcopy”, by S. Brandt and M. Mevorah, in Proc. Statistical Methods in Multi-image and Video Processing Workshop, ECCV 2006. However the method proposed in that publication does not provide a satisfactory estimate of the random movements in translation and/or rotation, and consequently does not make an acceptable reconstruction possible of the object under observation.

An aim of the invention is to provide methods enabling the volume of an object to be reconstructed on the basis of a section image sequence, these methods being applicable even when the positions and/or the orientations of the sections in the volume of said object are subject to uncertainty.

In one aspect, the invention thus provides a method of reconstructing the volume of an object from a sequence of section images of said object, said sections corresponding to different positions and/or orientations of an acquisition plane relative to the object, said positions and/or orientations being subject to uncertainties, the method being characterized in that it comprises:

a) selecting a finite base of functions on which the volume for reconstruction can be decomposed;

b) selecting a first quantification function for quantizing the difference between the real position and/or orientation of each section relative to said object and its nominal position and/or orientation;

c) selecting a second quantification function for quantizing the spatial coherence of the reconstructed volume;

d) selecting a third quantification function for quantizing the difference between the section images of the object and the corresponding sections of the reconstructed volume;

e) selecting an overall cost function, of value that depends on the values of said first, second, and third quantizing functions; and

f) jointly estimating the real positions and/or orientations of the section, together with the coefficient for decomposing the image of the object on said function base, by minimizing said overall cost function.

Said object is generally three-dimensional, but the invention may also be applied to reconstructing a two-dimensional object from a succession of single-dimensional sections. The term “volume” should therefore be understood broadly.

In particular embodiments of the invention:
Said finite base of functions on which the volume for reconstruction can be decomposed may be constituted by Gaussian functions.
Said finite base of functions on which the volume for reconstruction can be decomposed may be a base defining a self-reproducing kernel Hilbert space. Under such circumstances, said second quantification function for quantizing the spatial coherence of the reconstructed volume may be proportional to the norm of said self-reproducing kernel Hilbert space.
Said first quantification function for quantizing the difference between the real position and/or orientation of each section and its nominal position and/or orientation may be based on a Euclidean norm and/or a geodesic norm.
Said first quantification function for quantizing the difference between the real position and/or orientation of each section and its nominal position and/or orientation may depend on at least one calibration parameter characteristic of the instrument used for acquiring the section images of said object.
Said second quantification function may depend on at least one calibration parameter for calibrating spatial coherence, and said third quantification function may depend on at least one calibration parameter for calibrating the difference, said method also including, prior to step f), a joint estimation step d′) of estimating at least said difference and spatial coherence calibration parameters from said sequence of section images of said object.
Step d′) may include joint estimation of at least said difference and spatial coherence calibration parameters by a maximum likelihood method on the basis of said sequence of section images of said object. In particular, said estimation by a maximum likelihood method may be based on the assumption that said second quantification function for quantizing the spatial coherence of the reconstructed volume, and said third quantification function for quantizing the difference between the section images of the object and the corresponding sections of the reconstructed volume follow Gaussian distributions.
Said overall cost function may be a linear combination of said first, second, and third quantification functions.
Said step f) of jointly estimating the real positions and/or orientations of the sections together with the coefficients for decomposing the image of the object on said function base by minimizing said overall cost function may be performed by using a gradient descent method.
Said sections of the object may be obtained by successive nominal movements in translation of an image acquisition plane, having random rotation-translation movements that are unknown a priori superposed thereon.
In a variant, said sections of the object may be obtained by successive nominal movements in rotation of an image acquisition plane about a common axis, having random rotation-translation movements that are unknown a priori superposed thereon. Under such circumstances, said steps a) to f) may advantageously be repeated for at least two section sequences obtained by successive nominal rotations of an image acquisition plane, the axes of rotation corresponding to said two section sequences being substantially mutually orthogonal, and the reconstructions of the volume of the object as obtained from said two section sequences may be fused by interpolation, for example by spline smoothing.

In another aspect, the invention provides a method of reconstructing the volume of an object from a plurality of section image sequences of said object, each sequence being constituted by sections obtained by successive nominal movements in translation of an acquisition plane, the nominal orientation of said acquisition plane being different for each sequence and being known in imperfect manner. This method is referred to as the multiple stack (M.S.) protocol since it makes use of a multiplicity of “stacks” of sections of an object. Not only are the relative orientations of the different stacks known imperfectly, but within each stack random rotation-translation movements that are unknown a priori are superposed on the nominal movements in translation of the acquisition plane.

Such a method comprises:

A) estimating the relative positions and orientations of the observation plane for each of the sections of said sequences by a method as described above;

B) estimating the offsets and the orientation differences between the different sequences and relative to said object;

C) compensating the offsets and orientation differences between section image sequences; and

D) reconstructing said volume by interpolation from the section images of said sequences considered as constituting a single set.

In particular implementations:
Step B) of estimating the offsets and the orientation differences between different section image sequences of said object may be performed by means of principal component analysis. This principal component analysis may in particular be performed on binarized versions of said section image sequences. More precisely, each section image sequence may be binarized using a binarizing threshold that is jointly estimated together with a binarizing threshold of a sequence selected as a reference, said estimation being performed for each sequence other than the reference sequence by minimizing a function of the differences between the eigenvalues of the variance-covariance matrix of said sequence and the eigenvalues of the variance-covariance matrix of said reference sequence. In particular, said difference function may be given by:

$$ɛ ( τ , {τ}^{′} ) = {\sum }_{k} {\vert log {λ}_{k} - log {λ}_{k}^{′} \vert}^{2} .$$

where λₖ and λ′ₖ are the eigenvalues of the variance-covariance matrices respectively of the binarized sequence under consideration and of the reference binarized sequence, while τ and τ′ are the respective binarizing thresholds.

Another aspect of the invention is a method of reconstructing the volume of an object by making use of a plurality of section image sequences of said object, which sequences are of different natures. In particular, a first sequence may be obtained by movements in translation of an observation plane relative to said object (producing a “stack”), and at least one second sequence may be obtained by movements in rotation of an observation plane relative to said object. As in the above methods, random rotation-translation movements that are unknown a priori may be superposed on said movements in translation or in rotation of the observation plane associated with the various sections. Such a method comprises:

i) a preliminary reconstruction of said volume from said first image sequence using a method as described above;

ii) estimating the positions and orientations of the sections of said first and second sequences, and repositioning them in space on the basis of said estimates; and

iii) reconstructing said volume by interpolation from said repositioned second sequence(s) of sections.

In other words, the “stack” constituted by the first sequence of images is used to perform a preliminary reconstruction that serves solely to enable the sections that are obtained by movements in rotation (second sequence) to be positioned. It is the second sequence that is used for reconstructing the volume, so as to take advantage of the better spatial resolution it provides because of the above-mentioned axial aberration phenomenon.

This method is referred to as a “two-protocol” method since it combines two different types of acquisition.

In a variant, it is possible to use a plurality of first section image sequences of the object obtained by movements in translation of an observation plane relative to said object. Under such circumstances, the method comprises:

i) a preliminary reconstruction of said volume from said first image sequences using the above-described “M.S.” protocol;

ii) estimating the positions and the orientations of the sections of said second sequence(s), and repositioning them in space on the basis of said estimations; and

iii) reconstructing said volume by interpolation on the basis of said repositioned second image sequence(s) of sections.

In a variant, the first section image sequence of the object may be obtained by movements in rotation of an observation plane relative to said object, while the second section image sequence(s) of the object are obtained by movements in translation of said observation plane relative to the object. In other words, the roles of the “stacks” and of the sequence(s) obtained by movements in rotation are inverted. This method comprises in turn:

i) a preliminary reconstruction of said volume from said first image sequence by a method as described above;

ii) estimating the positions and the orientations of the sections of said second sequence(s), and repositioning them in space on the basis of said estimates; and

iii) reconstructing said volume by interpolation from said repositioned second image sequence(s) of sections.

This variant is advantageous when the axial resolution is better than the transverse resolution.

In particular implementations of a “two-protocol” type method:
Said step ii) of estimating the positions and the orientations of the sections of said second sequence(s), and of repositioning them in space on the basis of said estimates may comprise minimizing a quantification function for quantizing the difference between the section images of the object and the corresponding sections of the preliminary reconstructed volume.
Minimizing a quantification function for quantizing the difference between the section images of the object and the corresponding sections of the preliminary reconstructed volume may comprise: a first phase of preliminary estimation based on the assumption that all of the sections of said or each second sequence are obtained by shifts and/or movements in translation of said observation plane that are constant but unknown; and a second phase of refinement comprising estimating the random rotation-translation movements that are superposed on the movements in translation or rotation that are assumed to be constant of the observation plane associated with the various sections.
Said step iii) of reconstructing said volume from said repositioned second image sequence(s) of sections may be performed by interpolation of the spline smoothing type.

It is advantageous to observe that methods of the “M.S.” and “two-protocol” types may also be used in the absence of random translation-rotation movements that become superposed on the nominal movements of the acquisition plane.

The above-described methods apply in particular to circumstances in which the section image sequences of said object are acquired by confocal microscopy. Still more particularly, these methods apply to circumstances in which said object is placed in a container of a confocal microscope, said section image sequences of said object being acquired by moving said object relative to the container.

Nevertheless, the invention may also be applied to more conventional circumstances in which it is the focal plane of the microscope that moves, while the object remains stationary. What matters is that there is relative movement between the acquisition plane and the object.

Furthermore, the invention is not limited to the field of microscopy.

In yet another aspect, the invention provides a device for reconstructing the volume of an object, the device comprising: means for acquiring a sequence of section images of said object, said sections corresponding to different positions and/or orientations of an acquisition plane relative to the object; and data processor means for reconstructing the volume of said object from said sequence of section images thereof; the device being characterized in that: the positions and/or orientations of the acquisition plane corresponding to the various sections are subjected to uncertainties; and in that the data processor means are adapted to implement a method as described below.

Said means for acquiring a sequence of section images of said object may in particular comprise a confocal microscope fitted with a container for containing said object, and with means for moving said object relative to the container.

Other characteristics, details, and advantages of the invention appear on reading the description made with reference to the accompanying drawings given by way of example and showing, respectively:

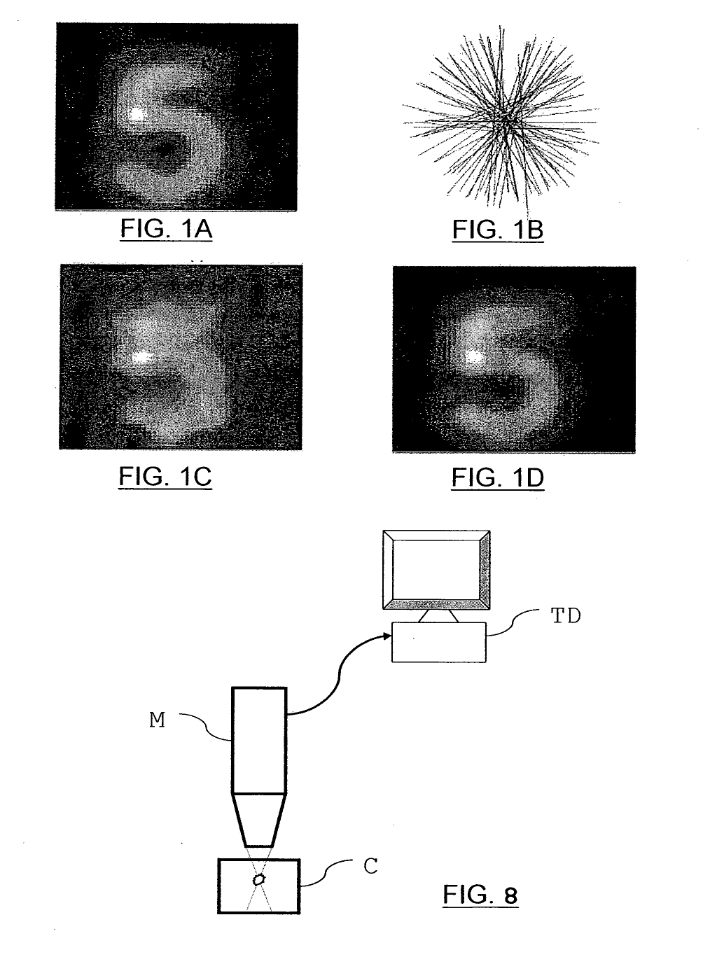

FIGS. 1A to 1D, a simple example of reconstructing a two-dimensional object from a plurality of one-dimensional sections;

FIG. 2, a flow chart of a reconstruction method in a first implementation of the invention;

FIG. 3, a flow chart of a reconstruction method in a second implementation of the invention (“M.S.” protocol);

FIG. 4, a flow chart of a method of reconstruction in a third implementation of the invention (“two-protocol”);

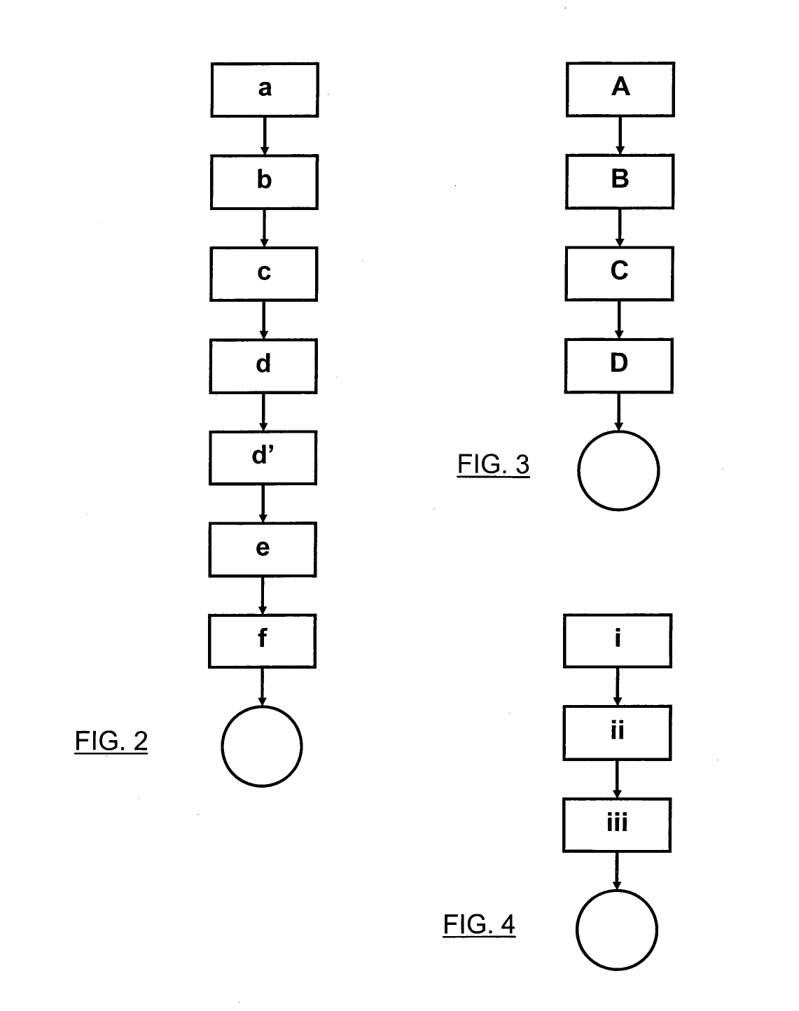

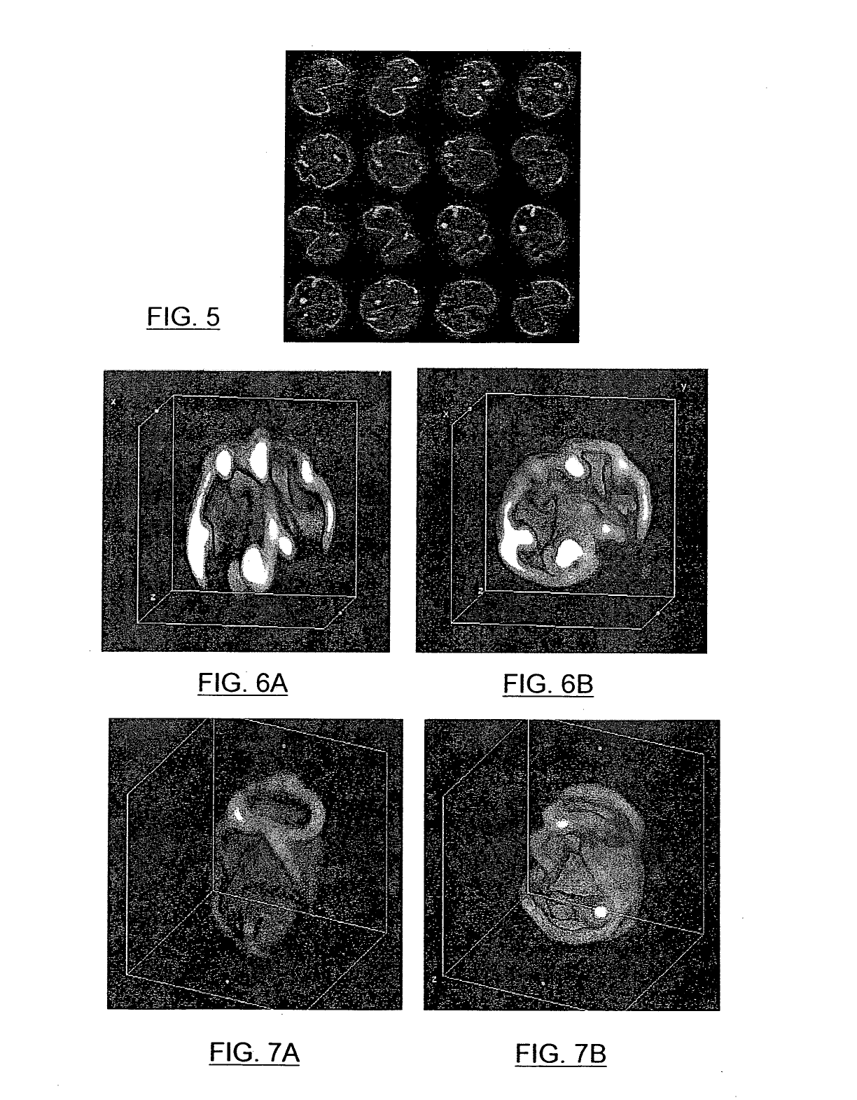

FIG. 5, a plurality of section images acquired by rotating an acquisition plane relative to a cell viewed by means of a confocal microscope;

FIGS. 6A, 6B, 7A, and 7B, reconstructions of said cell from a sequence of section images obtained by moving an acquisition plane respectively in translation (6A, 7A) and in rotation (6B, 7B) relative to said cell; and

FIG. 8, a device for implementing a reconstruction method of the invention.

FIGS. 1A to 1D serve to understand intuitively what the invention is about.

FIG. 1A shows a two-dimensional object, more particularly a black and white image of the digit “5”.

FIG. 1B shows a plurality of acquisition lines that “probe” the two-dimensional object. Nominally, the lines are obtained by rotating a base line through an angle Nφ₀ where N is an integer; in reality, it can be seen that random rotation-translation movements are superposed on said movement that is nominally in pure rotation.

FIG. 1C shows a reconstruction of the object obtained by assuming that the position and the orientation of each acquisition line coincides with its nominal position and orientation. It can be seen that the image is highly degraded because of the random rotation-translation movements that disturb the acquisition of the one-dimensional images.

Finally, FIG. 1D shows a reconstruction performed by a method of the invention. This reconstruction is practically perfect, in spite of the uncertainty that affects the position and the orientation of each acquisition line. Naturally, this is merely a simulation, so the real positions and orientations of the acquisition lines are known a priori, however no use was made of that knowledge in order to obtain the image of FIG. 1D (where such knowledge would not be available under operational conditions).

In order to describe the methods of the invention rigorously, consideration is given to an instrument (e.g. a confocal microscope) that enables a sequence of sections I={Iᵢ, i=1, . . . , n} of an object to be obtained by shifting and/or turning an acquisition plane relative to said object. The movement may be continuous or discrete. It matters little whether it is the acquisition plane that moves while the object remains stationary, or vice versa: what matters is that there is relative movement that enables the acquisition plane to “probe” the volume of the object.

The movements of the acquisition plane generated by the instrument are unstable to a greater or lesser extent. For example, when the instrument has been set to perform continuous turning movement, the position of the axis of rotation may vary over time about a position that was set initially. Furthermore, the axis may be subjected to parasitic movements in translation. Thus, relative to the sequence I, this movement gives rise to a sequence of micromovements Φ={φᵢ=(Rᵢ, Tᵢ), i=1, . . . , n} where Rᵢ and Tᵢ are respectively microrotations and microtranslations defining the position of the section Iᵢ. This sequence constitutes a degraded or “noisy” version of the nominal movements in rotation Φ⁰={φᵢ⁰=(R, 0), i=1, . . . , n} as set while adjusting the instrument.

Similarly, for an instrument that has been set to perform continuous movements in translation, the position of the translation axis may vary over time about a position that was initially set. Relative to the sequence I, this movement gives rise to a sequence of micromovements Φ={φᵢ=2(Rᵢ, Tᵢ), i=1, . . . , n} where Rᵢ and Tᵢ are respectively microrotations and microtranslations that define the position of the section Iᵢ. This sequence constitutes a degraded or “noisy” version of the nominal movement in translation Φ⁰={φᵢ⁰=(0, T), i=1, . . . , n} as set when adjusting the instrument.

The methods of the invention enable a 3D image of the object to be reconstructed from a sequence of sections of said object. The reconstruction consists in determining a volume of “densities” f={f(s), s ε [symbol] } on the basis of a sequence of sections I={Iᵢ(s), s ε [symbol] , 1=1, . . . , n}, the positions of the sections defined by Φ={φᵢ, i=1, . . . , n} not being known accurately. The term “position” of an acquisition plane designates a set of parameters completely defining its situation in space, including its orientation.

The “density” function f may, for example, express the gray levels of a monochromatic image; under such circumstances, f is a scalar function of spatial coordinates. For an image in color (or in false colors), f is a vector function, e.g. having a luminance component and two chrominance components.

To begin with, it is assumed that the instrument is adjusted so that a movement as set on the instrument of φ⁰=(R⁰, T⁰), with T⁰=0 for pure rotation and R⁰=Id for pure translation. The idea on which the present invention is based is to estimate simultaneously the positions {φᵢ} of the sections and the function f of the densities of the object. The estimated positions are in the neighborhood of the nominal movement φ⁰. The estimated volume is determined so as to optimize the spatial coherence of the densities of the volume. These two estimates are interdependent: the better position is estimated, the better the coherence of the densities. This procedure is applied to “articles” of d dimensions (typically d=2 or 3), the sections being of dimensions d−1. Below, it is assumed that d=3, always.

FIG. 2 is a flow chart of a reconstruction method in a first implementation of the invention.

Let I={Iᵢ, i=1, . . . , n} be a sequence of sections of the object that correspond to continuous movement either in rotation or in translation, as set by φ⁰. A reference plane H⁰ is initially selected by placing all of the section images at the same place in said plane. Let f={f(s), s ε [symbol] } be the unknown volume. The position of each of the sections in f may be defined by applying H₀ to an affine rotation φᵢ=(Rᵢ,Tᵢ). Let Φ={φᵢ, i=1, . . . , n} and Φ⁰={φ⁰, i=1, . . . , n}. The procedure described herein then serves to estimate f and Φ.

The first step a) of the method consists in selecting a finite base of functions on which the volume for reconstruction (or more precisely the function f representative of densities in said volume) can be decomposed. This step serves to represent the spatial function f by a finite number of coefficients, thereby giving a finite dimension to the optimization problem that is to be solved. This base may be constituted, for example, by a family of Gaussian functions.

Thereafter, in step b), a function J₀(Φ) is selected for quantizing the differences between the “real” movements of the acquisition plane relative to the nominal movements Φ⁰. For example:

$${𝒥}_{0} ( Φ ) = {\sum }_{i = 1}^{n} {d}^{2} ( {φ}_{i} , {φ}_{i}^{0} ) , \\ where$$

$${d}^{2} ( {φ}_{i} , {φ}_{i}^{0} ) = \frac{{d}^{2} ( {R}_{i} , {R}_{i}^{0} )}{{σ}_{R}^{2}} + \frac{{d}^{2} ( {T}_{i} , {T}_{i}^{0} )}{{σ}_{T}^{2}} , \\ d ( R , {R}^{′} ) = {cos}^{- 1} ( \frac{trace ( {R ( {R}^{′} )}^{- 1} ) - {1}_{m = 3}}{2} ) , geodesic distance$$

$${d}^{2} ( T , {T}^{′} ) = {‖ T - {T}^{′} ‖}_{ℝ \text{?}}^{2} , Euclidian distance$$

$$\text{?} \text{indicates text missing or illegible when filed}$$

The parameters σ_{R} and σ_{T} govern the spacing between φᵢ and φ⁰. These uncertainty parameters are calibration parameters characteristics of the instrument and they are assumed to be given.

The third step c) consists in selecting a function for quantizing the spatial coherence of the densities of f. The physical meaning of this spatial coherence function is to express the spatial “continuity” of the reconstructed volume: in general, it is expected that the volume to be reconstructed is not “fragmented”, i.e. with the function f then presenting numerous discontinuities, but rather a volume that is “continuous”, in which variations in f are more gradual. Naturally, the degree of spatial coherence of the object for reconstruction is not known a priori. That is why, advantageously, the spatial coherence function may depend on one or more calibration parameters that need to be estimated in turn. This point is developed below.

In a variant of the invention, the finite base of functions selected during step a) may be a base defining a Hilbert space with a self-reproducing kernel, and said second function for quantizing the spatial coherence of the reconstructed volume may be proportional to the norm of said Hilbert space having a self-reproducing kernel.

For example, the second function for quantizing the spatial coherence of the reconstructed volume may be given by:

$${𝒥}_{1} ( f ) = {σ}_{f}^{2} {‖ f ‖}_{ℋ}^{2} ,$$

where ∥f∥_{H} is a norm associated with a “self-reproducing kernel” k:

$$f ( \cdot ) = {\sum }_{1 \leq i \leq N} {α}_{i} k ( {s}_{i} , \cdot ) , \\ {‖ f ‖}_{ℋ}^{2} = {\sum }_{i , j = 1}^{N} {α}_{i} {α}_{j} k ( {s}_{i} - {t}_{j} ) , \\ k ( s , t ) = ρ ( ‖ ( s - t ) ‖ / {λ}_{f} ) .$$

The base function or “spatial interaction function” ρ may for example be a Gaussian function. N is the number of nodes of the grid on which f is calculated. The parameters {αᵢ} are the coordinates of f on the base functions {k(sᵢ, •)}. The parameters σ_{f} and λ_{f} constitute the above-mentioned calibration parameters, and they need to be estimated.

Step d) of the method comprises selecting a third function for quantifying the difference between the section images Iᵢ of the object and the corresponding sections of the reconstructed volume, f∘φᵢ. For example:

$${𝒥}_{2} ( f , Φ ) = {\sum }_{i = 1}^{n} {\sum }_{s ∈ {H}_{o}} {\vert f ( {ϕ}_{i} ( s ) ) - {I}_{i} ( s ) \vert}^{2} / {σ}_{ɛ}^{2} .$$

where σ_{ε} is another calibration parameter that depends on the object and that must therefore be estimated.

It should be observed that the order of steps a) to d) is of little importance.

The calibration parameters σ_{f}, λ_{f}, and σ_{ε} are estimated during a step d′). To do this, it is assumed that the differences (Iᵢ(s)−f∘φᵢ(s)) (here S belongs to H₀) between the acquired section and its correspondent in the object are distributed in application of a Gaussian relationship N(0, σ_{ε}²). It is also assumed that I is distributed according to the Gaussian relationship N(μ_{f}1_{H}_{₀},Γ_{θ}) for which the covariance matrix Γ_{θ} is:

Γ_{θ}(s,t)=σ_{f}²ρ(∥xₛ−xₜ∥/λ_{f})+σ_{ε}²1ₛ₌ₜ.

Here, 1_{H}_{₀} is a vector of dimension equal to that of the space H₀ and the elements are identically equal to 1, while 1ₛ₌ₜ is equal to 1 if s=t, and otherwise 0.

The maximum likelihood principle is thus used to jointly estimate the parameters θ=(μ_{f}, σ_{f}², λ_{f}, σ_{ε}²) at the value \hat{θ} that maximizes Σᵢ₌₁^{N} log P(Iᵢ|θ) with

$$log P ( {I}_{i} \vert θ ) = - \frac{1}{2 {σ}_{f}^{2}} {( \begin{matrix}{I}_{i} - \\ {μ}_{f} {1}_{{H}_{o}}\end{matrix} )}^{{ }^{′}} {Γ}_{θ}^{- 1} ( \begin{matrix}{I}_{i} - \\ {μ}_{f} {1}_{{H}_{o}}\end{matrix} ) - \frac{1}{2} log ( \vert {Γ}_{θ} \vert ) + constant$$

The following step e) comprises selecting an overall cost function or “coherence function” that depends on the three quantizing functions defined in the preceding steps. For example, it is possible to select a linear combination:

$$𝒥 ( f , Φ ) = {𝒥}_{0} ( Φ ) + {𝒥}_{1} ( f ) + {𝒥}_{2} ( f , Φ ) .$$

Thereafter, during step f), this function is minimized so as to obtain the reconstructed volume \hat{f} and the positions of the sections \hat{Φ}, e.g. by using a procedure based on gradient descent alternating between minimizing Φ and minimizing f in succession, this procedure being initialized with Φ⁰.

When the movement is a rotation, with the axis of rotation of R⁰ not being in the acquisition plane, the object has a region of conical or biconical shape that is never intercepted by the acquisition plane, thus making reconstruction of said region impossible. Under such circumstances:
a second rotation sequence I′ is considered about an axis of rotation that is more or less orthogonal to the preceding axis of rotation; and
the preceding steps a) to f) are repeated for this second sequence. This second reconstruction may be written \hat{f}′.

Two images are thus obtained, each presenting a zone in which reconstruction is impossible. To obtain a complete reconstruction, it is possible:
to “reposition” the reconstructed volumes one on the other; and
to interpolate continuously over [symbol] all of the data constituted by the union of \hat{f} and \hat{f}′, in particular by “spline” type smoothing.

The concepts of “smoothing” and “interpolation” need to be specified in greater detail. Reconstructing the volume amounts to estimating a density field f in three-dimensional space. For points x situated at the locations of the sections, f(x) approximates to the value of the section at point x: that is what is called a smoothing operation. For points x situated between sections, f(x) creates a value where there was none: that is what is called interpolation. In fact, the two operations are closely linked: the interpolation operation stems from the smoothing operation that creates a regular function f(x) in three-dimensional space. The above-described decomposition of the density function on a function base of finite dimension constitutes a form of smoothing/interpolation.

At least in principle, the reconstructed volumes can be repositioned by a method similar to that described below with reference to FIG. 3: the reconstructed volumes are segmented and their centers of gravity and their principal axes of inertia are made to coincide. However, it should be considered that the presence of two different non-reconstructed zones in the two volumes causes this offsetting to be difficult.

The algorithm of FIG. 2 applies in general to all kinds of (nominal) movements of the acquisition plane: pure rotations through an angle that is constant or variable, pure translation with a pitch that is constant or variable, or a combination of movements in rotation and in translation. FIGS. 3 and 4 relate to methods that are more specific, making use of particular combinations of acquisition sequences.

FIG. 3 is a flow chart for an algorithm that is referred to herein as the “multiple stack” protocol or “M.S.”. In accordance with this protocol, the instrument is adjusted to move the acquisition plane in pure translation so as to “scan” the object along its entire length in the selected orientation. Thereafter, this operation is repeated for at least one other orientation. These acquisitions in translation provide a set of “stacks” that, once repositioned relative to one another, enable the volume f to be estimated.

There are two difficulties: firstly, each individual sequence of movements in translation (each “stack”) is affected by random rotation-translation movements of the acquisition plane; secondly the relative positioning and orientation of the different stacks are known only imperfectly.

Let \vec{I}={\vec{I}ᵢ, i=1, . . . , n} be the first sequence of sections of the object corresponding to a movement in translation set on the apparatus by φ⁰=(Id, T⁰). Let \vec{I}′, \vec{I}″, etc. be the other sequences of movements in translation corresponding to the instrument having settings φ′⁰, φ″⁰, etc.

The first step A) of the method consists in applying the method of FIG. 2 to “position” each of the section images of a sequence in the corresponding stack. This step serves to determine the relative positions and orientations of the sections in a given stack, but not the relative orientations between the different stacks.

This step may be omitted if it is considered that the sequences are not perceptibly affected by the random movements in rotation-translation that are superposed on the nominal movements.

Thereafter, one stack \vec{I} is selected as the “reference stack”; the offsets and the differences in orientation of the other stacks \vec{I}′, \vec{I}″, etc. relative to said reference stack are estimated in step B), and then compensated in step C), in order to enable the volume to be reconstructed in step D).

In order to “reposition” a generic stack \vec{I}′ on the reference stack \vec{I}, the procedure is as follows:
A function is selected for binarizing the sections, having a threshold setting τ, thereby transforming \vec{I} into a binarized section \vec{I} such that \vec{I}ᵢ=1 or 0. For a pale object on a dark background, such a function may for example be \vec{I}ᵢ=1 if \vec{I}ᵢ>τ, else 0. Let τ′ be the binarizing parameter of \vec{I}′, defined in the same manner. The threshold parameters τ and τ′ need to be determined.
For each pair (τ, τ′), a principal component analysis of \vec{I} (or \vec{I}′) is performed on the cloud of points of [symbol] made up of the coordinates of pixels i such that \vec{I}ᵢ=1. The eigenvalues of the variance-covariance matrix of the cloud are written {λₖ, k=1,2,3} (and likewise {λ′ₖ, k=1,2,3} for the values associated with the cloud of \vec{I}).
Thereafter, (τ, τ′) is estimated by minimizing the function:

$$ɛ ( τ , {τ}^{′} ) = {\sum }_{k} {\vert log {λ}_{k} - log {λ}_{k}^{′} \vert}^{2} .$$

By using the previously obtained pair, it is possible to reposition the two corresponding clouds by causing their centers of gravity to coincide and also the eigenvectors of their variance-covariance matrices. The affine application of this repositioning operation is written φ′=(R′,T′) and the stacks repositioned on \vec{I} are written \vec{I}′_{φ(i)}, \vec{I}″_{φ″(i)}, etc.

These various operations are repeated for all of the stacks other than the reference stack. It should be observed that the threshold parameter τ is estimated on each occasion, and that its value is not the same on each iteration of the procedure.

Finally, in step D), the repositioned stacks, now considered as a single set, are interpolated by “spline” smoothing in three dimensions.

The method of FIG. 4, that is referred to as the “two-protocol” method is applied when at least one sequence \check{I} is available that has been obtained by rotation and at least one sequence \vec{I} is available that has been obtained by movement in translation. Initially, the translation sequence(s) is/are used to obtain a preliminary reconstruction \vec{f}. Thereafter, the positions of the sections \check{I}ᵢ are obtained by positioning in \vec{f}, the final reconstruction being based on \check{I}. This protocol is particularly suitable when the information provided by \vec{I} is less than the information provided by \check{I}. For example, when resolution is greater laterally (i.e. in the acquisition plane) than axially (perpendicularly to the plane), it is preferable in the final reconstruction to use the section sequences in rotation, and to make use of the sequences in translation only for the preliminary reconstruction.

Let \vec{I}={\check{I}ᵢ, i=1, . . . , n} be a sequence of sections of the object corresponding to rotations of the acquisition plane through a constant angle φ⁰. Let \check{I}′={\check{I}ᵢ, i=1, . . . , n} be a second sequence corresponding to continuous movement in rotation about an axis of rotation that is more or less orthogonal to the preceding axis of rotation. A reference plane H₀ is selected and all of the sections in rotation are put in the same place in said plane.

Let \vec{I}={\vec{I}ᵢ, i=1, . . . , m} be a sequence or “stack” of sections of the object corresponding to a movement in translation. Optionally, it is possible to take a second sequence of sections in translation \vec{I}′, or even more (\vec{I}″, \vec{I}′″, . . . ). If the movement in translation is not stable, each of the sections is positioned in the corresponding stack by applying the algorithm of FIG. 2. This positioning provides as many stacks as there are sequences.

Let f={f(s), s ε [symbol] } be the unknown volume for reconstruction. The position of each of the rotation sections \check{I}ᵢ in f is defined by applying to H₀ an affine rotation φᵢ=(Rᵢ,Tᵢ) that needs to be estimated as follows.

Step A): preliminary reconstruction. With only one stack \vec{I}, it suffices to interpolate the stack continuously over [symbol] , e.g. by using three-dimensional spline smoothing, with the result constituting an initial reconstruction written \vec{f}.

If a plurality of stacks are available, the algorithm of FIG. 3 is used. Because of uncertainties concerning the positioning of the stacks, this procedure calculates for each of the stacks \vec{I}′, \vec{I}″, etc., its position relative to the reference stack \vec{I}, and then uses these positions to reposition the stacks on said reference stack. All of these repositioned stacks are interpolated using three-dimensional spline smoothing, with the result constituting an initial reconstruction written \vec{f}.

Step B): estimating the positioning and estimating the sections of the second sequence(s), and repositioning them spatially.

This step is performed in two phases: a preliminary estimation in which it is assumed that the movement in rotation of the acquisition plane is exactly φ⁰=(R⁰, 0), i.e. uncertainties are temporarily ignored; and a refinement phase during which account is taken of the uncertainties that were previously ignored.

During the first phase, the positions of the sections are defined in stages. Firstly, the sections stored in the plane H₀ are deployed to put them into their rotation positions in space: the rotation position of the first section plane P₁ is then the result of an affine rotation ψ₁=(R₁,T₁) applied to H₀: P₁=R₁H₀+T₁, while the following section planes Pᵢ are obtained by successive application of R⁰ to the first section plane: Pᵢ=(R⁰)ⁱ⁻¹P₁. Thereafter, this set of sections in rotation is positioned in \vec{f}. Since the movement in rotation is assumed to be stable, the positions of the \vec{I}ᵢ in \vec{f} are given by a single affine rotation ψ=(R,T) applied to the Pᵢ. Finally, the positions of the sections are defined by the parameters φ¹=(ψ₁,ψ) which are estimated by minimizing:

$${\sum }_{i} {‖ {\breve{I}}_{i} - \vec{f} ( ψo {P}_{i} ) ‖}^{2}$$

in which expression Pᵢ depends on ψ₁.

During the second phase of step B), the estimates are refined so as to take account of the instabilities. The positions resulting from the preceding estimation are written Pᵢ¹. The final position is close to Pᵢ¹ and is defined by an affine rotation φᵢ=(Rᵢ,Tᵢ) applied to Pᵢ¹. Φ={φᵢ, i=1, . . . , n} is estimated by minimizing:

$${\sum }_{i} {‖ {\breve{I}}_{i} - \vec{f} ( {φ}_{i} o {P}_{i}^{1} ) ‖}^{2} .$$

Reconstruction step C) is performed by continuously interpolating the positioned sections \check{I}ᵢ over [symbol] , e.g. by using three-dimensional spline smoothing, with the result constituting a reconstruction of the volume f, written \check{f}.

When the axis of rotation of R⁰ is not in the acquisition plane, there exists a region of the object that is never intercepted by the acquisition plane and reconstruction of this region is therefore impossible. Under such circumstances, steps A) and B) are repeated for the sequence \check{I}′, and then all of sections \check{I}ᵢ and \check{I}′ᵢ are interpolated continuously over [symbol] using three-dimensional spline smoothing, the results constituting a reconstruction of the volume f, likewise written \check{f}.

More generally, it is possible to use a plurality of “second sequences” in rotation.

The description above relates to the preliminary reconstruction being obtained from one or more section sequences in translation with the final reconstruction being obtained from one or more section sequences in rotation. The converse is also possible; however, as mentioned above, using the images of two section sequences in rotation about different axes can be difficult.

The invention may be applied particularly but not exclusively, to confocal microscopy. By way of example, in this field it makes the following possible:
virtual reconstruction in three dimensions of individual living and non-adherent cells on the basis of a sequence of two-dimensional images obtained by fluorescent confocal microscopy; and
elimination of the axial aberration that is inherent to microscopy and improvement in spatial resolution.

Conventional techniques for three-dimensional reconstruction of a cell require the cell to be fixed to a transparent surface. The cell is positioned manually thereon in various orientations. In each orientation, a section sequence in vertical translation is acquired, using a protocol that is known as the “z-stack” protocol. Fusing those stacks then gives a three-dimensional representation of the cell, but that representation can nevertheless not escape completely from axial aberration and lack of resolution. In addition, that method is difficult or impossible to apply to cells that are non-adherent.

In the American Type Cell Culture Collection (ATCC) that makes 4000 cell types available to researchers, and about 1500 of them are non-adherent. Amongst them, 280 are human cells that are under-used because of lack of three-dimensional analysis.

Above-mentioned document EP 1 413 911 describes a microscope fitted with a “cell manipulator” instrument that enables a cell that is in suspension in aqueous solution to be captured and then to be moved in rotation or in translation under the lens of the microscope. That movement thereby enables the cell to be examined under various orientations. The central portion of that instrument is a capture “cage” placed under the lens. It is an electric field generated in the cage that serves to capture and move the cell, in correspondence with the settings of the fields that can be adjusted at the cage. The first experimental advantage of that instrument is that it enables articles in suspension to be analyzed, which is particularly advantageous for non-adherent cells (such as those of the immune system).

Unfortunately, reconstruction requires relatively accurate knowledge of the orientations of the cell. However, the “manipulator” of document EP 1 413 911 enables the orientation of the cell to be adjusted only coarsely, thereby making it impossible to use that novel technique on a routine basis.

The “cell manipulator” also presents the advantage of making it possible to obtain acquisitions “in rotation”, thus making it possible to be unaffected by the “axial aberration” that is inherent to optical microscopes and that is associated with the fact that the resolution perpendicular to the focal plane (z axis) is half the resolution within the focal plane (xy). Because of this effect, a spherical object appears to be elliptical, its long axis being oriented in the Oz direction. Until now, that problem has constituted a major obstacle for three-dimensional microscopic imaging since such imaging is based essentially on z-stack type acquisitions. However the advantages provided by the device of document EP 1 413 911 have previously remained “virtual” in the absence of a reconstruction method that makes it possible to overcome uncertainties concerning the movement of the cell.

This is where one of the main contributions of the invention lies.

FIG. 5 shows a plurality of section images acquired by rotating an acquisition plane relative to a cell viewed by means of the confocal microscope of document EP 1 413 911.

FIGS. 6A and 7A are two views of a reconstruction of the same cell, performed in accordance with the method of the invention in application of the z-stack protocol (a sequence of section images acquired by the cell moving in translation relative to the focal plane).

FIGS. 6B and 7B are two views corresponding to reconstruction of the same cell, but implemented in accordance with the method of the invention, using a “two-protocol” method (see FIG. 4), in which the final reconstruction was performed on the basis of a sequence of section images acquired by rotating the cell relative to the focal plane. Comparing FIGS. 6A/6B and 7A/7B shows that the axial aberration phenomenon is eliminated as is made possible by making use of sequences acquired “in rotation”.

FIG. 8 is a highly diagrammatic representation of a confocal microscope M fitted with a cell manipulator C and a data processor device TD for implementing a reconstruction method of the invention.

1. A method of reconstructing the volume of an object from a sequence of section images of said object, said sections corresponding to different positions and/or orientations of an acquisition plane relative to the object, said positions and/or orientations being subject to uncertainties, the method being characterized in that it comprises:
a) selecting a finite base of functions on which the volume for reconstruction can be decomposed;
b) selecting a first quantification function for quantizing the difference between the real position and/or orientation of each section relative to said object and its nominal position and/or orientation;
c) selecting a second quantification function for quantizing the spatial coherence of the reconstructed volume;
d) selecting a third quantification function for quantizing the difference between the section images of the object and the corresponding sections of the reconstructed volume;
e) selecting an overall cost function, of value that depends on the values of said first, second, and third quantizing functions; and
f) jointly estimating the real positions and/or orientations of the section, together with the coefficient for decomposing the image of the object on said function base, by minimizing said overall cost function.

2. A method according to claim 1, wherein said object is a three-dimensional object.

3. A method according to claim 1, wherein said finite base of functions on which the volume for reconstruction can be decomposed is constituted by Gaussian functions.

4. A method according to claim 1, wherein said finite base of functions on which the volume for reconstruction can be decomposed is a base defining a self-reproducing kernel Hilbert space.

5. A method according to claim 4, wherein said second quantification function for quantizing the spatial coherence of the reconstructed volume is proportional to the norm of said self-reproducing kernel Hilbert space.

6. A method according to claim 1, wherein said first quantification function for quantizing the difference between the real position and/or orientation of each section and its nominal position and/or orientation is based on a Euclidean norm and/or a geodesic norm.

7. A method according to claim 1, wherein said first quantification function for quantizing the difference between the real position and/or orientation of each section and its nominal position and/or orientation depends on at least one calibration parameter characteristic of the instrument used for acquiring the section images of said object.

8. A method according to claim 1, wherein said second quantification function depends on at least one calibration parameter for calibrating spatial coherence, and said third quantification function depends on at least one calibration parameter for calibrating the difference, said method also including, prior to step f), a joint estimation step d′) of estimating at least said difference and spatial coherence calibration parameters from said sequence of section images of said object.

9. A method according to claim 8, wherein step d′) includes joint estimation of at least said spatial coherence and difference calibration parameters by a maximum likelihood method on the basis of said sequence of section images of said object.

10. A method according to claim 9, wherein said estimation by a maximum likelihood method is based on the assumption that said second quantification function for quantizing the spatial coherence of the reconstructed volume, and said third quantification function for quantizing the difference between the section images of the object and the corresponding sections of the reconstructed volume follow Gaussian distributions.

11. A method according to claim 1, wherein said overall cost function is a linear combination of said first, second, and third quantification functions.

12. A method according to claim 1, wherein said step f) of jointly estimating the real positions and/or orientations of the sections together with the coefficients for decomposing the image of the object on said function base by minimizing said overall cost function is performed by using a gradient descent method.

13. A method according to claim 1, wherein said sections of the object are obtained by successive nominal movements in translation of an image acquisition plane, having random rotation-translation movements that are unknown a priori superposed thereon.

14. A method according to claim 1, wherein said sections of the object are obtained by successive nominal movements in rotation of an image acquisition plane about a common axis, having random rotation-translation movements that are unknown a priori superposed thereon.

15. A method according to claim 14, wherein said steps a) to f) are repeated for at least two section sequences obtained by successive nominal rotations of an image acquisition plane, the axes of rotation corresponding to said two section sequences being substantially mutually orthogonal, and wherein the reconstructions of the volume of the object as obtained from said two section sequences are fused by interpolation.

16. A method of reconstructing the volume of an object from a plurality of section image sequences of said object, each sequence being constituted by sections obtained by successive nominal movements in translation of an acquisition plane having random rotation-translation movements that are unknown a priori superposed thereon, the nominal orientation of said acquisition plane being different for each sequence and being known in imperfect manner, said method comprising:
A) estimating the relative positions and orientations of the observation plane for each of the sections of said sequences by a method according to claim 1;
B) estimating the offsets and the orientation differences between the different sequences and relative to said object;
C) compensating the offsets and orientation differences between section image sequences; and
D) reconstructing said volume by interpolation from the section images of said sequences considered as constituting a single set.

17. A method according to claim 16, wherein step B) of estimating the offsets and the orientation differences between different section image sequences of said object is performed by means of principal component analysis.

18. A method according to claim 17, wherein said principal component analysis is performed on binarized versions of said section image sequences.

19. A method according to claim 18, wherein each section image sequence is binarized using a binarizing threshold that is jointly estimated together with a binarizing threshold of a sequence selected as a reference, said estimation being performed for each sequence other than the reference sequence by minimizing a function of the differences between the eigenvalues of the variance-covariance matrix of said sequence and the eigenvalues of the variance-covariance matrix of said reference sequence.

20. A method according to claim 19, wherein said difference function is given by:
$$ɛ ( τ , {τ}^{′} ) = {\sum }_{k} {\vert log {λ}_{k} - log {λ}_{k}^{′} \vert}^{2} .$$
where λₖ and λ′ₖ are the eigenvalues of the variance-covariance matrices respectively of the binarized sequence under consideration and of the reference binarized sequence, while τ and τ′ are the respective binarizing thresholds.

21. A method of reconstructing the volume of an object from a plurality of section image sequences of said object, wherein said plurality of sequences comprises:
a first section image sequence of the object obtained by movements in translation of an observation plane relative to said object; and
at least one second section image sequence of the object obtained by movements in rotation of an observation plane relative to said object;
where random rotation-translation movements that are unknown a priori are superposed on said movements in translation or in rotation of the observation plane associated with the various sections;
said method comprising:
i) a preliminary reconstruction of said volume from said first image sequence using a method according to claim 1;
ii) estimating the positions and orientations of the sections of said first and second sequences, and repositioning them in space on the basis of said estimates; and
iii) reconstructing said volume by interpolation from said repositioned second sequence(s) of sections.

22. A method of reconstructing the volume of an object from a plurality of section image sequences of said object, wherein said plurality of sequences comprises:
a plurality of first section image sequences of the object obtained by movements in translation of an observation plane relative to said object; and
at least one second section image sequence of the object obtained by movements in rotation of an observation plane relative to said object;
where random rotation-translation movements that are unknown a priori a priori are superposed on said movements in translation or in rotation of the observation plane associated with the various sections;
said method comprising:
i) a preliminary reconstruction of said volume from said first image sequences using a method according to claim 16;
ii) estimating the positions and the orientations of the sections of said second sequence(s), and repositioning them in space on the basis of said estimations; and
iii) reconstructing said volume by interpolation on the basis of said repositioned second image sequence(s) of sections.

23. A method of reconstructing the volume of an object from a plurality of section image sequences of said object, wherein said plurality of sequences comprises:
a first sequence of image sections of the object obtained by movements in rotation of an observation plane relative to said object; and
at least one second sequence of section images of the object obtained by movements in translation of an observation plane relative to said object;
where random rotation-translation movements that are unknown a priori are superposed on said movements in translation or rotation of the observation plane associated with the various sections;
said method comprising:
i) a preliminary reconstruction of said volume from said first image sequence by a method according to claim 1;
ii) estimating the positions and the orientations of the sections of said second sequence(s), and repositioning them in space on the basis of said estimates; and
iii) reconstructing said volume by interpolation from said repositioned second image sequence(s) of sections.

24. A method according to claim 21, wherein said step ii) of estimating the positions and the orientations of the sections of said second sequence(s), and of repositioning them in space on the basis of said estimates comprises minimizing a quantification function for quantizing the difference between the section images of the object and the corresponding sections of the preliminary reconstructed volume.

25. A method according to claim 24, wherein minimizing a quantification function for quantizing the difference between the section images of the object and the corresponding sections of the preliminary reconstructed volume comprises:
a first phase of preliminary estimation based on the assumption that all of the sections of said or each second sequence are obtained by shifts and/or movements in translation of said observation plane that are constant but unknown; and
a second phase of refinement comprising estimating the random rotation-translation movements that are superposed on the movements in translation or rotation that are assumed to be constant of the observation plane associated with the various sections.

26. A method according to claim 21, wherein said step iii) of reconstructing said volume from said repositioned second image sequence(s) of sections is performed by interpolation of the spline smoothing type.

27. A method according to claim 1, wherein said section image sequences of said object are acquired by confocal microscopy.

28. A method according to claim 27, wherein said object is disposed in a container of a confocal microscope, and wherein said section image sequences of said object are acquired by moving said object relative to the container.

29. A device for reconstructing the volume of an object, the device comprising:
means for acquiring a sequence of section images of said object, said sections corresponding to different positions and/or orientations of an acquisition plane relative to the object; and
data processor means for reconstructing the volume of said object from said sequence of section images thereof;
the device being characterized in that:
the positions and/or orientations of the acquisition plane corresponding to the various sections are subjected to uncertainties; and in that
the data processor means are adapted to implement a method according to claim 1.

30. A device according to claim 29, wherein said means for acquiring a sequence of section images of said object comprise a confocal microscope fitted with a container for containing said object, and with means for moving said object relative to the container.
